(19) United States
(12) Patent Application Publication
(10) Pub. No.: US 2026/0368583 A1
(43) Pub. Date: Nov. 19, 2026

(54) INFORMATION PROCESSING APPARATUS AND INFORMATION PROCESSING METHOD

(71) Applicant: Hitachi, Ltd., Tokyo (JP)

(72) Inventors: Ryo NAGAI, Tokyo (JP); Tatsuya TOMARU, Tokyo (JP); Naoto SATO, Tokyo (JP); Saki SUSA, Tokyo (JP)

(21) Appl. No.: 19/146,381

(22) PCT Filed: Apr. 14, 2023
(86) PCT No.: PCT/JP2023/015150

§ 371 Date: Jul. 8, 2025

(51) Int. Cl. G06N 10/20

(52) U.S. Cl. CPC G06N 10/20

(57) ABSTRACT

An object is to visualize a two-qubit state as well as quantum entanglement in a manner that they can be clearly and intuitively understood. An aspect of the present invention is to provide an information processing apparatus including: an input interface that receives at least one of information on a state of a plurality of qubits and information on an operation related to a plurality of qubits; a visualization processing unit that generates a parameter for visualizing at least one of a state of two arbitrary qubits of the plurality of qubits and an operation related to two arbitrary qubits in the operation related to the plurality of qubits; and an output interface that outputs output information based on the parameter, in which the information processing apparatus displays, on an output apparatus, a diagram representing a Bloch sphere and quantum entanglement based on the output information.

### TECHNICAL FIELD

The present invention relates to a quantum computer, and particularly, to a technique for visualizing a quantum state in a quantum computer.

### BACKGROUND ART

A quantum computer is a new calculator in which a quantum state of a two-level system is a minimum unit of information, and the calculation power of the quantum computer is expected to surpass the calculation power of a classic computer. The potential of the quantum computer depends on properties (quantumness) specific to quantum system, such as superposition of quantum states and quantum entanglement, and it is essential to understand the quantumness to understand the action of the quantum computer.

A method of visualizing the quantum state is known in a conventional technique, and a technique for using a Bloch vector and a density matrix to visualize the quantum state is disclosed in Patent Literature 1.

### CITATION LIST

### Patent Literature

Patent Literature 1: US2020/0104739 A1

### SUMMARY OF INVENTION

### Problem to be Solved by the Invention

Currently, there is no known method of clearly visualizing the quantum entanglement. For example, the Bloch vector as a representative representation method cannot represent the quantum entanglement. In addition, although the density matrix has information including the quantum entanglement, the representation method, such as using two 4×4 bar graphs for the representation, is complicated, and it is difficult to immediately determine the degree of quantum entanglement. Therefore, the development of a representation method that allows to intuitively understand the quantum entanglement is necessary to support the further development by the quantum developer.

Thus, an object is to visualize a two-quantum state as well as quantum entanglement in a manner that they can be clearly and intuitively understood.

### Means for Solving the Problem

An aspect of the present invention is to provide an information processing apparatus including: an input interface that receives at least one of information on a state of a plurality of qubits and information on an operation related to a plurality of qubits; a visualization processing unit that generates a parameter for visualizing at least one of a state of two arbitrary qubits of the plurality of qubits and an operation related to two arbitrary qubits in the operation related to the plurality of qubits; and an output interface that outputs output information based on the parameter, in which the information processing apparatus displays, on an output apparatus, a diagram representing a Bloch sphere and quantum entanglement based on the output information.

Another aspect of the present invention is to provide an information processing method executed by an information processing apparatus including an input interface, an output interface, a storage apparatus, an operation unit, and a visualization processing unit, the visualization processing unit executing: an input step of receiving at least one of information on a state of a plurality of qubits and information on an operation related to a plurality of qubits; a visualization step of generating a parameter group for visualizing at least one of a state of two arbitrary qubits in the plurality of qubits and an operation related to two arbitrary qubits in the operation related to the plurality of qubits; and an output step of outputting output information based on the parameter group to display a diagram representing a Bloch sphere and quantum entanglement on an output apparatus based on the parameter group.

In a specific and suitable aspect of the present invention, the information on the state of the plurality of qubits is received in the input step, a first step of acquiring a density matrix of a two-qubit state from the information on the state of the plurality of qubits and a second step of calculating a qubit correlation matrix and a density matrix of single qubits from the density matrix are executed in the visualization step, and a first parameter for displaying a 3×3 matrix representing quantum entanglement based on the density matrix of the two-qubit state and a second parameter for displaying Bloch vectors to be displayed on the Bloch sphere based on the density matrix of the single qubits are output in the output step.

In another specific and suitable aspect of the present invention, the information on the operation related to the plurality of qubits is received in the input step, a third step of acquiring a unitary matrix representing a two-qubit operation from the information on the operation related to the plurality of qubits and a fourth step of obtaining a first operation decomposing the unitary matrix and acting on single qubits alone and a second operation acting on two qubits are executed in the visualization step, and in the output step, a third parameter for displaying Bloch vectors to be displayed in the Bloch sphere based on the first operation is output, and a fourth parameter for displaying a point inside or outside of a tetrahedron in a cube having one side of π based on the second operation, the point being displayed on top of the cube and the tetrahedron, is output.

### Advantageous Effect of the Invention

The two-qubit state as well as the quantum entanglement can be visualized in a manner that they can be clearly and intuitively understood.

### BRIEF DESCRIPTION OF DRAWINGS

FIG. 1 is a quantum circuit diagram describing a quantum circuit.

FIG. 2 is a block diagram describing a whole image of a system of embodiments according to embodiment 1.

FIG. 3 is a flow chart illustrating a process for displaying a quantum state according to embodiment 1.

FIG. 4 is an explanatory diagram describing an example of display of a two-qubit state (state without entanglement) according to embodiment 1.

FIG. 5 is an explanatory diagram describing an example of display of a two-qubit state (moderately entangled state) according to embodiment 1.

FIG. 6 is an explanatory diagram describing an example of display of a two-qubit state (maximally entangled state) according to embodiment 1.

FIG. 7 is an explanatory diagram describing another example of display of the two-qubit state (moderately entangled state) according to embodiment 1.

FIG. 8 is a flow chart describing a process for displaying a quantum operation according to embodiment 2.

FIG. 9 is a flow chart describing a selection method of a two-qubit operation according to embodiment 2.

FIG. 10 is an explanatory diagram describing Cartan decomposition of the two-qubit operation according to embodiment 2.

FIG. 11A is an explanatory diagram describing a Bloch vector (K₁₁, K₂₁) of the two-qubit operation according to embodiment 2.

FIG. 11B is an explanatory diagram describing a Bloch vector (K₁₂, K₂₂) of the two-qubit operation according to embodiment 2.

FIG. 12 is a perspective view describing a tetrahedron representing an entanglement generation structure of the two-qubit operation according to embodiment 2.

FIG. 13 is an explanatory diagram describing the Bloch vectors of the two-qubit operation according to embodiment 2.

FIG. 14 is an explanatory diagram describing the Bloch vectors of the two-qubit operation according to embodiment 2.

FIG. 15 is an explanatory diagram describing a strength of quantum entanglement according to embodiment 2.

FIG. 16 is a flow chart describing an acquisition method of tetrahedron coordinates representing the entanglement generation structure of the two-qubit operation according to embodiment 2.

FIG. 17 is an explanatory diagram describing a local equivalent operation 1 necessary for acquiring the coordinates on the tetrahedron according to embodiment 2.

FIG. 18 is an explanatory diagram describing a local equivalent operation 2 necessary for acquiring the coordinates on the tetrahedron according to embodiment 2.

FIG. 19 is a table describing local equivalent operations necessary for acquiring the coordinates on the tetrahedron according to embodiment 2.

FIG. 20 is an explanatory diagram describing an example of display of a two-qubit operation (operation without quantum entanglement) according to embodiment 2.

FIG. 21 is an explanatory diagram describing an example of display of a two-qubit operation (moderate entanglement generation operation) according to embodiment 2.

FIG. 22 is an explanatory diagram describing an example of display of a two-qubit operation (maximal entanglement generation operation) according to embodiment 2.

FIG. 23 is a table describing an example of display of the moderate entanglement generation operation according to embodiment 2.

FIG. 24 is a block diagram describing an outline of a system in receiving input information from an emulator in a classic calculator according to embodiment 3.

FIG. 25 is a block diagram describing an outline of a system in receiving input information from an emulator in a classic calculator connected outside according to embodiment 3.

FIG. 26 is a block diagram describing an outline of a system in receiving input information from a quantum calculator according to embodiment 3.

### MODES FOR CARRYING OUT THE INVENTION

Embodiments will be described in detail with reference to the drawings. However, the interpretation of the present invention should not be limited to the description of the embodiments illustrated below. Those skilled in the art can easily understand that the specific configuration of the present invention can be changed without departing from the idea and the scope of the present invention.

In the configurations of the embodiments described below, the same reference signs are commonly used for the same parts or parts with similar functions in different drawings, and the description may not be repeated.

Different affixes may be provided to the same reference signs in the description when there are a plurality of elements with the same or similar functions. However, the affixes may not be provided in the description when there is no need to distinguish the plurality of elements.

The terms such as “first,” “second,” and “third” in the present specification and the like are provided to identify the constituent elements, and the terms do not necessarily limit the numbers, the orders, and the details of the constituent elements. In addition, the numbers for identifying the constituent elements are used on the basis of context, and the numbers used in one context may not represent the same components in another context. Furthermore, the constituent elements identified by numbers may also have functions of the constituent elements identified by other numbers.

To facilitate the understanding of the invention, the position, size, shape, range, and the like of each component illustrated in the drawings and the like may not represent the actual position, size, shape, range, and the like. Therefore, the present invention may not be limited to the positions, sizes, shapes, ranges, and the like disclosed in the drawings and the like.

The publications, patents, and patent applications cited in the present specification are incorporated herein in their entirety.

The constituent elements expressed in singular forms in the present specification shall include plural forms unless the context clearly indicates otherwise.

In one example of the embodiments described below, a two-qubit state is displayed in a diagram representing a Bloch sphere and quantum entanglement. A 3×3 bar graph or an ellipse is used for the diagram representing the quantum entanglement. In addition, the present invention can display not only the two-qubit state, but also a two-qubit operation, and in that case, the quantum entanglement is displayed by one point in a cube or one point in a tetrahedron.

According to the technique of the embodiments, the two-qubit state and the two-qubit operation as well as the quantum entanglement can be clearly displayed. Therefore, the quantum entanglement and the quantum entanglement generation structure can be intuitively understood, and the quantum calculator and the quantum algorithm can be efficiently developed.

The present embodiments are based on the quantum mechanics. Therefore, general properties of the quantum mechanics will be described first.

In the quantum mechanics, an observable quantity (physical quantity) a is represented by eigenvalues of a Hermitian matrix A. The value obtained by measuring a is one of eigenvalues {a₁, a₂, . . . } of A. A quantum state |ψ> is described by a linear combination of the eigenvectors (eigenstates) {|a₁>, | a₂>, . . . }. That is, complex numbers {c₁, c₂, . . . } can be used to write |ψ>=c₁|a₁>+c₂|a₂>+ . . . . The time evolution of the quantum system is described by a unitary operator acting on the quantum state. When a is measured in the quantum system, the quantum state of the system irreversibly transitions to one of {aᵢ>} according to the measured value. For example, if a₁ is observed, the state of the system transitions from |ψ> to |a₁>. This phenomenon is also called “wave function collapse.” The probability that a physical quantity aₖ is measured, that is, the probability that the quantum system transitions to |aₖ> is provided by |cₖ|². According to the law of conservation of probability, |c₁|²+|c₂|² . . . =1 is requested.

A quantum computer is a calculator that artificially constructs a quantum system (two-level system) including two eigenstates {|0>, |1>}, and the quantum state of the system is the minimum unit of information. The minimum unit of information is called a qubit, and complex numbers c₁ and c₂ satisfying |c₁|²+|c₂|²=1 can be used to represent the qubit by |ψ>=c₁|0>+c₂|1>.

The qubit can be represented by a vector including complex numbers as components. For example, when a vector representation of |0>=(1 0)^{T}, |1>=(0 1)^{T} (superscript T denotes transposition) is used, the one-qubit state can be represented by |ψ₁>=c₁|0>+c₂|1>=(c₁, c₂)^{T}. An operation on one qubit in the quantum computer is described by a 2×2 unitary matrix U₁ acting on the vector |ψ₁>. U₁ can be written by a linear combination of 2×2 Hermitian matrices generally defined by (equation 1).

$$\begin{matrix}[ Expression 1 ] & \\ I = {σ}_{0} = ( \begin{matrix}1 & 0 \\ 0 & 1\end{matrix} ) , X = {σ}_{1} = ( \begin{matrix}0 & 1 \\ 1 & 0\end{matrix} ) , & ( equation 1 )\end{matrix}$$

$$Y = {σ}_{2} = ( \begin{matrix}0 & - i \\ i & 0\end{matrix} ) , Z = {σ}_{3} = ( \begin{matrix}1 & 0 \\ 0 & - 1\end{matrix} ) .$$

A multiple-qubit state is described as a linear combination of direct products (tensor products) of the eigenstates {|0>, |1>}. For example, a two-qubit state can be written by a linear combination of |0>*|0>=|00>=(1 0 0 0)^{T}, |0>*|1>=|01>=(0 1 0 0)^{T}, |1>*|0>=|10>=(0 0 1 0)^{T}, and |1>*|1>=|11>=(0 0 0 1)^{T} (here, * denotes a vector cross product). That is, complex numbers c₁, c₂, c₃, and c₄ satisfying |c₁|²+|c₂|²+|c₃|²+|c₄|²=1 can be used to write the two-qubit state as |ψ₂>=c₁|00>+c₂|01>+c₃|10>+c₄|11>. An operation on the two qubits is described by a 4×4 unitary matrix U₂ acting on the vector |ψ₂>. U₂ can be generally written by a linear combination of direct products of two Hermitian matrices of (equation 1). Hereinafter, the direct products of σₐ and σ_{b} (a, b=0, 1, 2, 3) will be represented by σₐσ_{b}. The n>2-qubit states and the operations Un are similarly defined (n is a natural number).

A diagram in which operations on qubits are arranged in chronological order will be referred to as a quantum circuit diagram.

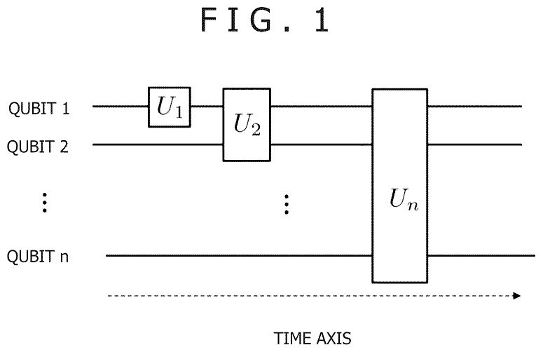

FIG. 1 illustrates an example of a quantum circuit diagram of n>2 qubits. In the quantum circuit diagram, the qubits are vertically arranged, and the operations on the qubits are sequentially written from left to right in chronological order. U₁, U₂, and Un in the diagram represent a one-qubit operation, a two-qubit operation, and an n-qubit operation, respectively.

The one-qubit pure state |ψ₁> and the operation U₁ can be represented by using vectors on the surface of a 3-sphere with radius of 1. The vectors are called “Bloch vectors,” and the sphere is called a “Bloch sphere.” A density matrix ρ₁=|ψ₁><ψ₁| defined based on |ψ₁> (<ψ₁ denotes a complex conjugate of |ψ₁>) is used to represent the relationship between the one-qubit state and the Bloch vector (x, y, z) as x=Tr[X.ρ₁], y=Tr[Y.ρ₁], Z=Tr[Z.ρ₁]. Here, . denotes a matrix product, and Tr[A] denotes a trace of a matrix A. The Bloch sphere x²+y²+z²=1 is determined from the condition of Tr[(ρ₁)²]=Tr[ρ₁]=1. The one-qubit operation U₁ is represented by a difference between the Bloch vector representing the input state and the Bloch vector representing the output state. The state of a multiple-qubit system can also be represented by a plurality of Bloch vectors when the qubit state can be divided by the direct product of the one-qubit state.

However, the quantum entanglement cannot be represented only by the Bloch vectors. The quantum entanglement is a phenomenon that by measuring a qubit state, the other qubit state is determined, and the quantum entanglement is quantumness specific to the multiple-qubit system. For example, the two-qubit state |Bell>=(½)^{1/2}(|00>+| 11>) is an example of the state with quantum entanglement. The quantum state |Bell> cannot be divided by the direct product of the one-qubit state, and therefore, the quantum state |Bell> cannot be described by the Bloch vectors. Accordingly, the quantum operations that generate the quantum entanglement cannot be described only by the change in the Bloch vectors.

The present embodiments provide a new quantum system representation method of explicitly representing the quantum entanglement in the two-qubit system. The quantum entanglement is an important index in designing the quantum computer, and the quantitative representation of the quantum entanglement is highly demanded. Hereinafter, the embodiments will be described with reference to the drawings.

### Embodiment 1

The present embodiment provides an information processing apparatus that inputs a plurality of qubit states or a plurality of qubit operations and that outputs their properties in a manner that the quantum entanglement becomes apparent. An outline of the present information processing apparatus will be described in the present embodiment.

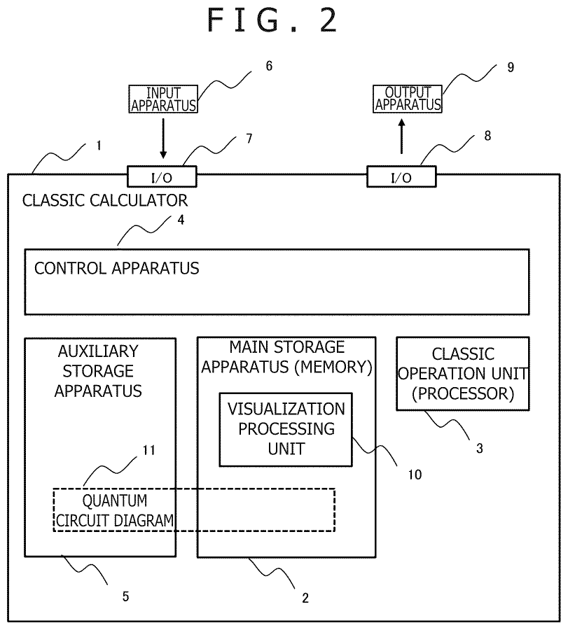

FIG. 2 illustrates an example of the configuration of the information processing apparatus of the present embodiment. As with a normal classic calculator, the present information processing apparatus (classic calculator 1) exchanges data with a main storage apparatus (memory) 2 that is a storage unit and a classic operation unit (processor) 3 that is an operation unit and repeats the exchange to advance the operations. They are controlled by a control apparatus 4. The process executed by the classic operation unit 3 is stored in the main storage apparatus 2. An auxiliary storage apparatus 5 is used when the storage capacity of the main storage apparatus 2 is insufficient. An input apparatus 6 is used to input data and programs, and the input information there is transmitted to the classic calculator 1 through an input interface 7. An output result is displayed on an output apparatus 9 through an output interface 8.

The present information processing apparatus includes a visualization processing unit 10 in the main storage apparatus 2 in addition to the components described above. The visualization processing unit 10 is, for example, software executed by the classic operation unit 3. The visualization processing unit 10 generates a parameter group for visualizing the qubit states and the operations. Information on a quantum circuit diagram 11 as input information for the present information processing apparatus is, for example, saved in the main storage apparatus 2 and also in the auxiliary storage apparatus 5 as necessary from the input apparatus 6 through the input interface 7.

The information processing apparatus of embodiment 1 generates information visualized based on the quantum circuit diagram 11 in the information processing apparatus. Two qubits to be visualized can be selected by displaying the quantum circuit diagram 11 on the output apparatus 9 through the output interface 8 and designating two arbitrary qubits from the input interface 7. The qubits to be visualized may be qubits as operation results or may be qubits in the middle of the operation. The states of the qubits as the operation results or the qubits in the middle of the operation can be recognized by, for example, performing a simulation based on the quantum circuit diagram 11.

Therefore, the visualization processing unit 10 receives the information on the quantum circuit diagram 11 and generates a parameter group for visualizing the qubit states and the operations. The parameter group generated here is displayed on the output apparatus 9 through the output interface 8. The output results here include a Bloch sphere and a diagram representing the Bloch vectors and the quantum entanglement based on the parameter group.

Next, the display of the two-qubit state will be described. The input is a density matrix of the two-qubit quantum state, and the output is a diagram representing two Bloch vectors and the quantum entanglement.

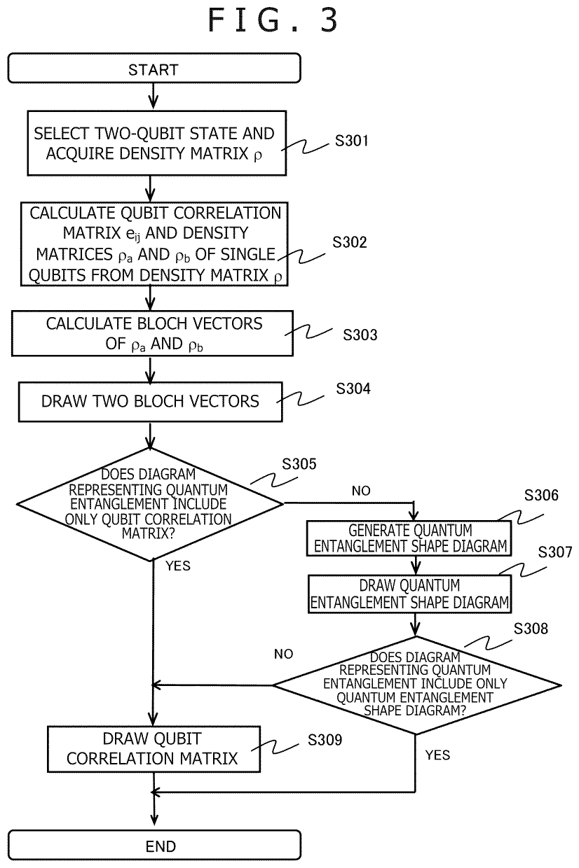

Arithmetic processing executed by the visualization processing unit 10 to output the state display will be illustrated with reference to FIG. 3. The visualization processing unit 10 first reads the quantum circuit diagram 11 and acquires a density matrix ρ of the two-qubit state as input obtained from the operation according to the quantum circuit diagram 11 (S301). When the number of qubits in the input state is equal to or greater than three, only two qubits are selected from among the plurality of qubits, and the behaviors of the qubits other than the two qubits are ignored. The density matrix ρ in the two-qubit state as input is provided by a 4×4 Hermitian matrix, and the density matrix ρ can be decomposed as in (equation 2).

$$\begin{matrix}[ Expression 2 ] & \\ ρ = \frac{1}{{2}^{2}} [ ( II ) + {\sum }_{i = 1}^{3} {a}_{i} ( {σ}_{i} I ) + {\sum }_{i = 1}^{3} {b}_{i} ( I {σ}_{i} ) + {\sum }_{i = 1}^{3} {\sum }_{j = 1}^{3} {c}_{ij} ( {σ}_{i} {σ}_{j} ) ] & ( equation 2 )\end{matrix}$$

Expansion coefficients are provided as in (equation 3).

$$\begin{matrix}[ Expression 3 ] & \\ {a}_{i} = Tr [ ( {σ}_{i} I ) \cdot ρ ] , {b}_{i} = Tr [ ( I {σ}_{i} ) \cdot ρ ] , & ( equation 3 )\end{matrix}$$

$${c}_{ij} = Tr [ ( {σ}_{i} {σ}_{j} ) \cdot ρ ] .$$

Next, the density matrix ρ is decomposed as in (equation 4) (S302).

$$\begin{matrix}Expression 4 ] & \\ ρ = {ρ}_{a} ⊗ {ρ}_{b} + \frac{1}{{2}^{2}} {\sum }_{i = 1}^{3} {\sum }_{j = 1}^{3} {e}_{ij} ( {σ}_{i} {σ}_{j} ) & ( equation 4 )\end{matrix}$$

$${ρ}_{a} = \frac{1}{2} [ I + {\sum }_{i = 1}^{3} {a}_{i} {σ}_{i} ]$$

$${ρ}_{b} = \frac{1}{2} [ I + {\sum }_{i = 1}^{3} {b}_{i} {σ}_{i} ]$$

$${e}_{ij} = {c}_{ij} - {a}_{i} {b}_{j}$$

Here, eᵢⱼ is a matrix representing the correlation of the two qubits. In the present specification and the like, eᵢⱼ will be referred to as a “qubit correlation matrix.” The qubit correlation matrix is generally a 3×3 real matrix, and the matrix represents the quantum entanglement between two qubits. When the qubit correlation matrix is a zero matrix, the matrix corresponds to the state without quantum entanglement.

Next, density matrices pa and pb of single qubits obtained by the decomposition are represented by Bloch vectors (S303). The components are calculated by (equation 5) where vector a and vector b are the Bloch vectors representing pa and Pb.

[Expression 5]

\vec{a}=(Tr[X.ρₐ],Tr[Y.ρₐ],Tr[Z.ρₐ])

\vec{b}=(Tr[X.ρ_{b}],Tr[Y.ρ_{b}],Tr[Z.ρ_{b}]) (equation 5)

The Bloch vectors are provided as part of the output of the state display.

The norms of the Bloch vectors are generally smaller than 1. This restriction comes from a condition of Tr[ρ²] <=Tr[ρ]=1. Particularly, Tr[ρ²]=Tr[ρ]=1 holds when ρ is in the pure state, and as a result, the norms of the Bloch vectors are as in (equation 6).

$$\begin{matrix}[ Expression 6 ] & \\ {a}^{2} = {b}^{2} = \sqrt{4 - E} - 1 & ( equation 6 )\end{matrix}$$

$${a}^{2} = {\vert \vec{a} \vert}^{2} , \qquad {b}^{2} = {\vert \vec{b} \vert}^{2}$$

$$\begin{matrix}E = {\sum }_{i = 1}^{3} {\sum }_{j = 1}^{3} ( {c}_{ij}^{2} - {a}_{i}^{2} {b}_{j}^{2} ) \\ = {\sum }_{i = 1}^{3} {\sum }_{j = 1}^{3} {c}_{ij} ( {c}_{ij} + {a}_{i} {b}_{j} )\end{matrix}$$

Here, E denotes a quantity with non-zero value when the qubit correlation matrix is a non-zero matrix. That is, it can be understood that the two Bloch vectors are generally vectors on a Bloch sphere with the radius smaller than 1. The degree of the collapse of radius is proportional to the degree of the quantum entanglement. Therefore, the lengths of the Bloch vectors represent the level of the quantum entanglement. Note that the Bloch sphere is completely collapsed in the case of the maximally entangled state, and the Bloch vectors are zero vectors.

The two Bloch vectors obtained as described above are drawn on two Bloch spheres (S304). These are provided as part of the output of the two-qubit state.

Next, a diagram representing the quantum entanglement is introduced. The diagram representing the quantum entanglement displays at least one of a diagram representing values of the qubit correlation matrix and a “quantum entanglement shape diagram” introduced below. The user can select, as the diagram representing the quantum entanglement, one of only the quantum entanglement shape diagram, only the qubit correlation matrix, and the quantum entanglement shape diagram and the qubit correlation matrix, and the display can be freely selected according to the selection of the user (S305).

The values of the qubit correlation matrix representing the two-qubit operation are represented by a 3×3 graph. The representation may be a three-dimensional graph or may be a two-dimensional table.

Non-negative singular values (e₁, e₂, e₃) of the qubit correlation matrix are used to define the quantum entanglement shape diagram by a three-dimensional (x, y, z) real space satisfying x²/e₁+y²/e₂+z²/e₃<=1. In the case of the maximally entangled state, the quantum entanglement shape diagram includes a 3-sphere with radius of 1, and the quantum entanglement shape diagram includes only the origin in the case of the state without entanglement. A general entangled state is a space in which an ellipse inside the 3-sphere with radius of 1 is the boundary. The quantum entanglement shape diagram is a diagram intuitively representing the property of the quantum entanglement, and the user can observe the degree of the collapse of the quantum entanglement shape diagram relative to the sphere to recognize the level of the quantum entanglement. The quantum entanglement shape diagram is generated in this way (S306).

The generated quantum entanglement shape diagram is drawn (S307), and whether to include only the quantum entanglement shape diagram in the diagram representing the quantum entanglement or to also include the qubit correlation matrix is selected (S308). When the qubit correlation matrix is necessary, the qubit correlation matrix is also drawn (S309).

The diagram representing the two Bloch vectors and the quantum entanglement obtained by the process is drawn as a final output on the display that is the output apparatus 9 through the output interface 8. Here, “the diagram representing the quantum entanglement” denotes at least one of the quantum entanglement shape diagram and the quantum entanglement correlation matrix. The quantum entanglement can be represented by either one of the quantum entanglement shape diagram and the quantum entanglement correlation matrix. The quantum entanglement shape diagram allows to intuitively figure out the quantum entanglement, and the quantum entanglement correlation matrix can include more detailed information. The user can optionally select them.

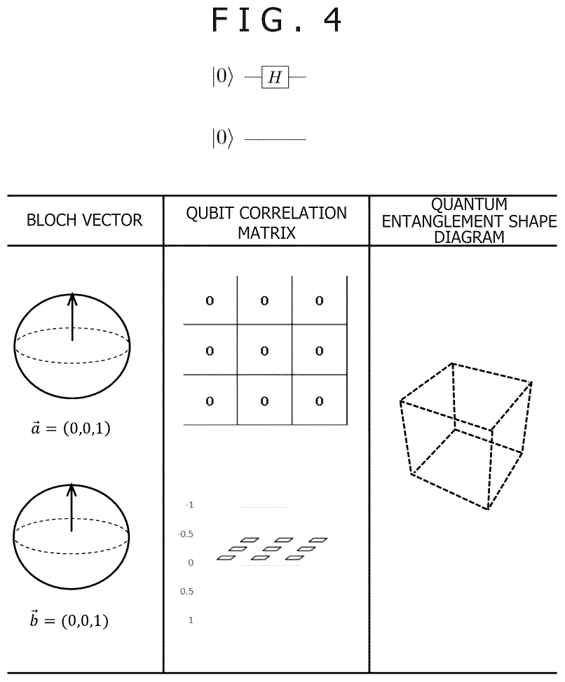

The display method of the two-qubit state has been described so far. Specific examples of display of the two-qubit state will be illustrated below with reference to FIGS. 4 to 6.

Here, |a>=(H1)|00>, |b>=(rootSWAP) (HI)|00>, and |c>=(CNOT)(HI)|00> will be considered as examples of a state without quantum entanglement |a>, a moderate quantum entanglement state |b>, and a maximally entangled state |c>, and examples of display of each two-qubit state will be illustrated.

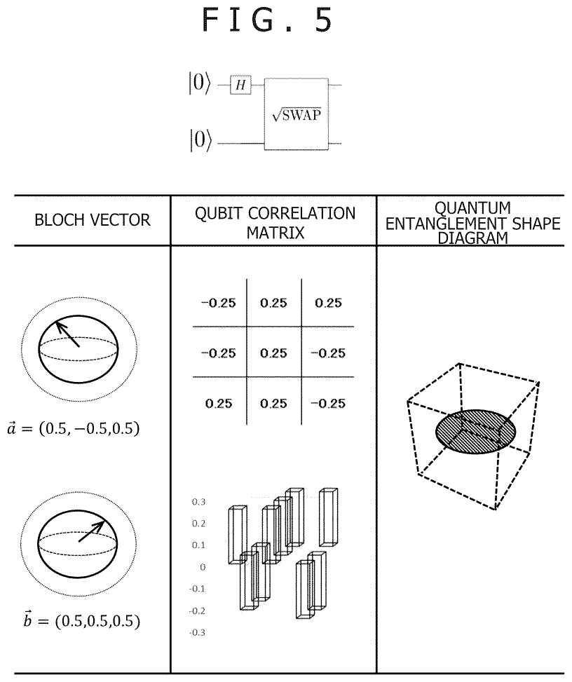

FIG. 4 illustrates an example of display of the state without quantum entanglement |a>. The Bloch vectors are illustrated on the left column of the table, the qubit correlation matrix and its graphical display are displayed on the center column, and the quantum entanglement shape diagram is illustrated on the right column (similar in FIGS. 5 to 7). The qubit correlation matrix of the state without quantum entanglement is a zero matrix. Therefore, the quantum entanglement shape diagram includes only the origin. In the example, the quantum entanglement shape diagram is displayed based on a cube with side of 1, and its origin (0, 0, 0) is the center of gravity of the cube. The Bloch vectors include vector a=(0, 0, 1) and vector b=(1, 0, 0).

FIG. 5 illustrates an example of display of the moderately entangled state |b>. The qubit correlation matrix of the moderately entangled state is a non-zero matrix. In the example, the matrix includes {{−0.25, 0.25, 0.25}, {−0.25, 0.25, −0.25}, {0.25, 0.25, −0.25}}. The matrix components are two-dimensionally or three-dimensionally displayed to obtain the graphical display in the center column of FIG. 5. In the example, the matrix components are provided on a two-dimensional plane, and the values of the components are indicated by prisms in positive and negative directions. The singular values of the matrix are calculated to obtain e₁=½, e₂=½, and e₃=¼, and the quantum entanglement shape diagram includes a space satisfying 2x²+2y²+4z²<=1 as illustrated in the example in the right column of FIG. 5. The Bloch vectors include vector a=(0.5, −0.5, 0.5) and vector b=(0.5, 0.5, 0.5). The lengths of the Bloch vectors are smaller than 1, and it can be understood that there is quantum entanglement.

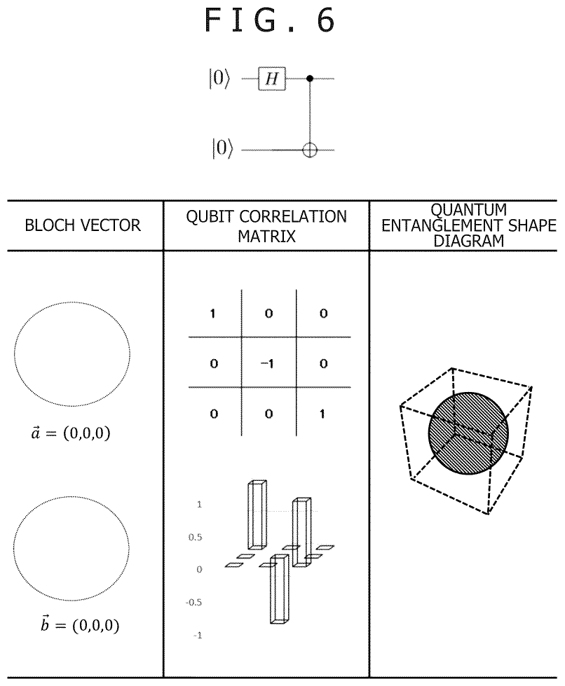

FIG. 6 illustrates an example of display of the maximally entangled state |c>. The correlation matrix in the maximally entangled state of this state is a diagonal matrix including values −1 or 1. In the example of state |c> of the present embodiment, the matrix includes {{1, 0, 0}, {0, −1, 0}, {0, 0, 1}}. The matrix components are two-dimensionally or three-dimensionally displayed to obtain the graphical display illustrated in the center column of FIG. 6. The singular values of the matrix are calculated to obtain e₁=e₂=e₃₌₁, and the quantum entanglement shape diagram includes a sphere with radius of 1 as illustrated in the right column of FIG. 6. The Bloch vectors include vector a and vector b with (0, 0, 0). The lengths of the Bloch vectors are 0, and it can be understood that there is maximal quantum entanglement.

The two Bloch vectors (vector a and vector b) representing the two-qubit state may be displayed together in one Bloch sphere.

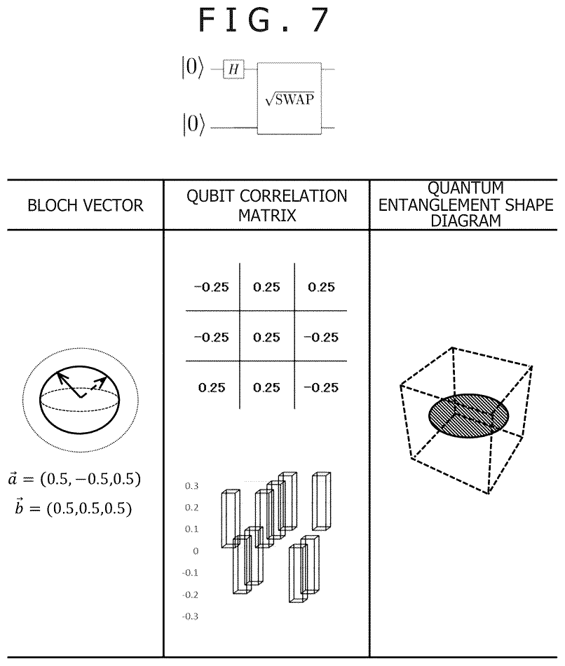

FIG. 7 illustrates an example in which the Bloch vectors in the moderate quantum entanglement state |b> are drawn in one Bloch sphere. Solid and dotted arrows in the left column of FIG. 7 represent the vector a=(0.5, −0.5, 0.5) and vector b=(0.5, 0.5, 0.5), respectively. The display of the qubit correlation matrix and the quantum entanglement shape diagram is the same as the display described above.

As described above, the radius of the Bloch sphere changes according to the degree of quantum entanglement, in the Bloch spheres drawn in FIGS. 4 to 7 in the present embodiment. Although the extent of the quantum entanglement can be recognized only by the size of the Bloch sphere, the quantum entanglement shape diagram and the quantum entanglement correlation matrix allow to figure out more detailed information such as the direction of entanglement.

### Embodiment 2

The display of the two-qubit state has been described so far. Hereinafter, a change in the two-qubit state, that is, the display of the two-qubit operation, will be described. In this embodiment, the display allows to consider whether the operation generates quantum entanglement.

Although the operation can also be represented as an amount of change in the two-qubit state, this cannot represent the property unique to the operation. Therefore, an acquisition method for a diagram clearly representing the quantum entanglement generation structure of the operation will be described in the present embodiment.

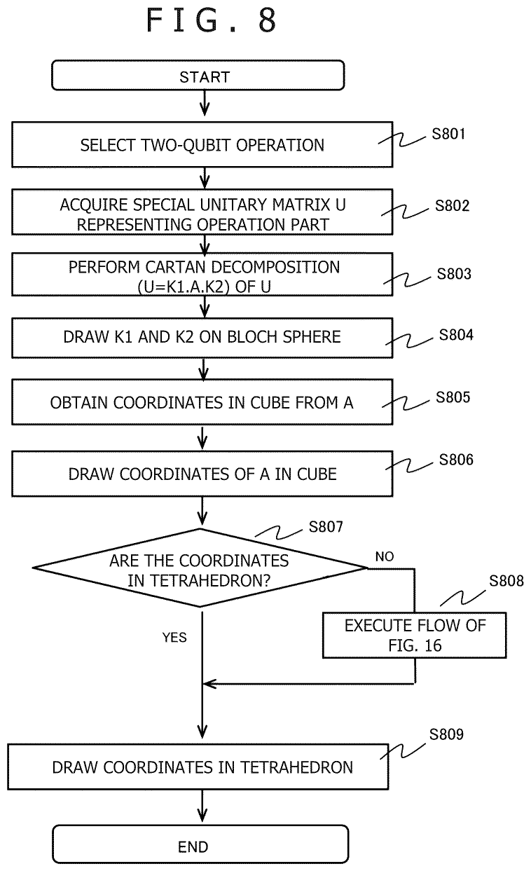

FIG. 8 illustrates a process executed by the visualization processing unit 10 to acquire the representation of the two-qubit operation. FIG. 8 is a diagram in which the input is a unitary matrix representing the two-qubit operation, and the output represents a change in the two Bloch vectors and the quantum entanglement. First, a subsystem to be analyzed is selected from the quantum circuit diagram 11 (S801).

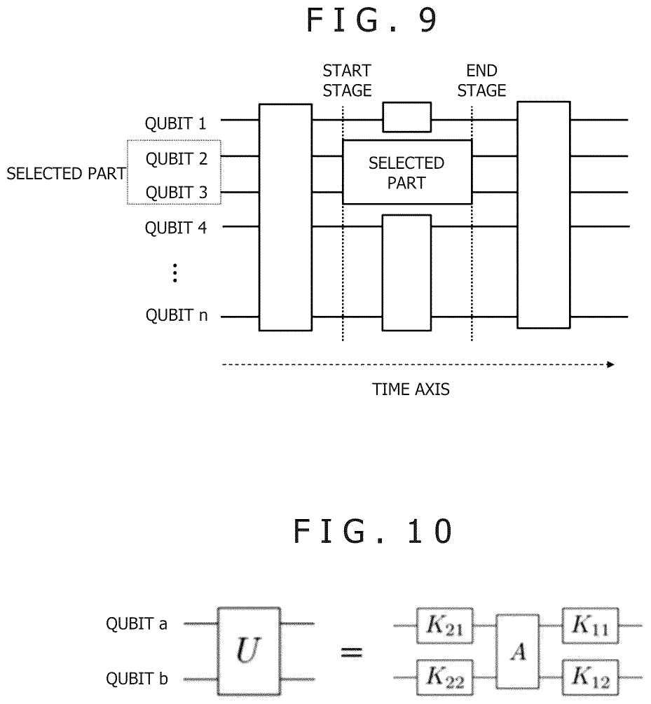

FIG. 9 illustrates a selection method for the subsystem. First, two qubits are selected from among a plurality of qubits, and appropriate start stage and end stage are selected. Hereinafter, an operation acting on only the selected two qubits in the range from the designated start stage to end stage will be mainly described. In FIG. 9, qubit 2 and qubit 3 are selected from among n>3 qubits. Hereinafter, qubit 2 will be referred to as qubit a, and qubit 3 will be referred to as qubit b. The operation included in the part described as “selected part” in FIG. 9 is to be analyzed.

The quantum circuit diagram as illustrated in FIG. 9 is displayed on the output apparatus 9 as display that can be visually recognized by the visualization processing unit 10 based on the quantum circuit diagram 11 recorded in the main storage apparatus 2 or the auxiliary storage apparatus 5. The user can execute a necessary process such as selecting the range of operation in which the generation status of the quantum entanglement is to be visualized, through the input apparatus 6.

The selected two-qubit operation can be represented by using a 4×4 unitary matrix V. The matrix V is represented by 16 real parameters. One of them corresponds to an operation for globally converting the phase of the quantum state, and the operation does not have a special meaning in the quantum calculation. Therefore, a special unitary matrix U excluding one parameter corresponding to the global conversion will be considered below. V can be used to define U as U=(detV)^{-1/4}V. Here, detV represents a determinant of V. In this way, the visualization processing unit 10 acquires the special unitary matrix U for displaying the operation part (S802).

Next, the matrix U is decomposed as in (equation 7) (S803).

$$\begin{matrix}[ Expression 7 ] & \\ U = {K}_{1} \cdot A \cdot {K}_{2} & ( equation 7 )\end{matrix}$$

$$where$$

$${K}_{1} = {K}_{11} {K}_{12} \qquad {K}_{2} = {K}_{21} {K}_{22}$$

$${K}_{11} = {e}^{\frac{i}{2} ( {l}_{11} XI + {l}_{12} YI + {l}_{13} ZI )}$$

$${K}_{12} = {e}^{\frac{i}{2} ( {l}_{21} IX + {l}_{22} IY + {l}_{23} IZ )}$$

$${K}_{21} = {e}^{\frac{i}{2} ( {r}_{11} XI + {r}_{12} YI + {r}_{13} ZI )}$$

$${K}_{22} = {e}^{\frac{i}{2} ( {r}_{21} IX + {r}_{22} IY + {r}_{23} IZ )}$$

$$A = {e}^{\frac{i}{2} ( {c}_{1} XX + {c}_{2} YY + {c}_{3} ZZ )}$$

Here, coefficients {rᵢⱼ, lᵢⱼ, cᵢ} are real numbers equal to or greater than −π and smaller than +π. The decomposition is called “Cartan decomposition.”

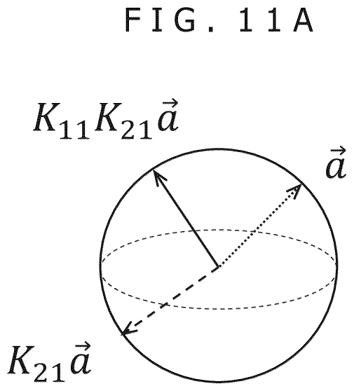

FIG. 10 illustrates a diagram in which the Cartan decomposition is represented by a quantum circuit diagram. A method of obtaining (K₁, K₂, A) and (c₁, c₂, c₃) from U will be described later. In the present embodiment, all of A, K₁₁, K₁₂, K₂₁, and K₂₂ obtained by the Cartan decomposition are illustrated and visualized. Not only A with aggregation of origins of quantum entanglement regarding two qubits, but also K₁₁, K₁₂, K₂₁, and K₂₂ regarding one qubit are visualized to allow comprehensive visualization of the quantum operation. In the example below, K₁₁, K₁₂, K₂₁, and K₂₂ will be displayed by a Bloch sphere, and A will be displayed by a cube or a tetrahedron.

Two Bloch vectors can be used to represent K₁ and K₂. This is because as illustrated in FIG. 10, all of K₁₁, K₁₂/K₂₁, and K₂₂ are operations acting on single qubits alone, and the quantum entanglement is not generated in the operations. For example, K₁₁ and K₂₁ are operations acting on only qubit a, and the operations can be represented as a change in the Bloch vector a. That is, three Bloch vectors of vec{a}, K₂₁vec{a}, and K₁₁K₂₁vec{a} can be displayed to represent (K₁₁, K₂₁). Here, vec{a} denotes vector a. Similarly, (K₁₂, K₂₂) can also be represented as a change in the Bloch vector b. That is, three Bloch vectors of vec{b}, K₂₂vec{b}, and K₁₂K₂₂vec{b} can be displayed to represent (K₁₂, K₂₂) (S804). Here, vec{b} denotes vector b.

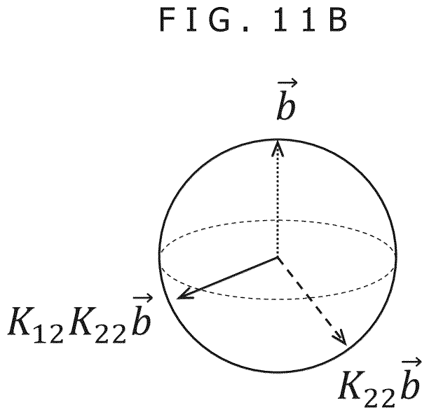

FIGS. 11A and 11B illustrate an example of the Bloch vector representation of (K₁₁, K₁₂, K₂₁, K₂₂). FIG. 11A is a diagram representing (K₁₁, K₂₁), and a dotted line, a broken line, and a solid line represent vec{a}, K₂₁vec{a}, and K₁₁K₂₁vec{a}, respectively. Similarly, FIG. 11B is a diagram representing (K₁₂, K₂₂), and a dotted line, a broken line, and a solid line represent vec{b}, K₂₂vec{b}, and K₁₂K₂₂vec{b}, respectively. The changes in the Bloch vectors (two Bloch spheres) are provided as part of the output of the operation display. In the display method, the reference states (vec{a}, vec{B}) need to be appropriately designated. The user uses the input apparatus 6 before drawing to designate the reference Bloch vectors.

Although the method of using two Bloch spheres has been described as the Bloch vector representation method for (K₁, K₁₂, K₂₁, K₂₂) here, there are also representation methods of using one or four Bloch spheres. The details of the methods will be described below. The user can use the input apparatus 6 to select a favorable representation method.

On the other hand, the operation A of FIG. 10 cannot be represented by the Bloch vectors. This is because as illustrated in FIG. 10, A is an operation across two qubits and is a part for generating the quantum entanglement. The quantum entanglement generation operation A can be displayed as one point on a cube in which the length of one side is π. This is because A is represented by a set (c₁, c₂, c₃) of real numbers equal to or greater than −π and smaller than +π, as expressed in (equation 7). The one point (c₁, c₂, c₃) on the cube is drawn to visualize A.

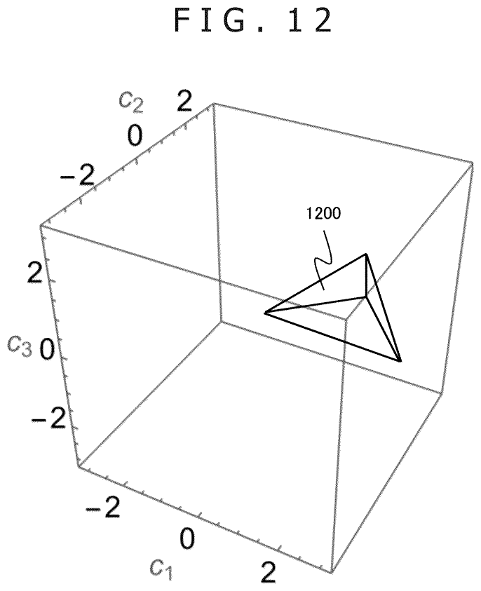

FIG. 12 is a perspective view (image diagram on the display screen) describing a tetrahedron 1200 representing the entanglement generation structure of the two-qubit operation. An example of related publicly known literature includes “Geometric theory of nonlocal two-qubit operations” Jun Zhang, Jiri Vala, Shankar Sastry, and K. Birgitta Whaley, Phys. Rev. A 67, 042313-Published 18 Apr. 2003.

It should be noted that in general, the solution (K₁, K₂, A) to the Cartan decomposition illustrated in (equation 7) or FIG. 10 is not uniquely determined. However, the decomposition in which (c₁, c₂, c₃) are one point on the tetrahedron 1200 illustrated in FIG. 12 is uniquely determined. The tetrahedron is defined as (c₁, c₂, c₃) satisfying c₁<=π/2 when 0<=c₃<=c₂<=c₁<T, c₁+c₂<=π, and c₃=0. Therefore, not only the coordinates (c₁, c₂, c₃) in the cube, but also the coordinates on the tetrahedron 1200 are drawn as the diagram uniquely representing the property of the quantum entanglement generation operation. The property of A is visualized by this. An acquisition method for the coordinates on the tetrahedron uniquely indicating the property of A (S805) will be described later.

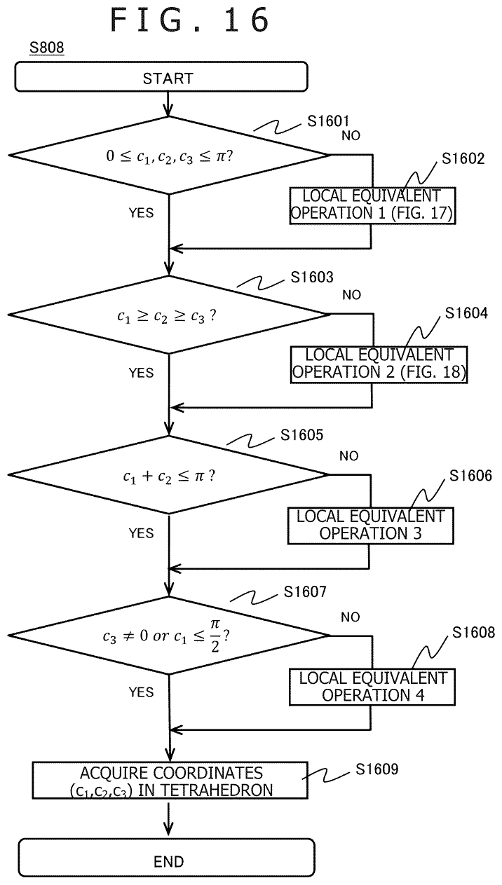

The acquired coordinates of A are drawn in the cube (illustrated in FIG. 12) (S806). In a preferred embodiment, whether the coordinates of A are in the tetrahedron 1200 is determined (S807). If the coordinates of A are not in the tetrahedron 1200, later, a local equivalent operation (S808) illustrated in FIG. 16 is performed to acquire the coordinates in the tetrahedron 1200.

The diagram representing the Bloch sphere and the quantum entanglement obtained by the process is drawn as a final output on the output apparatus 9 (S809).

Up to six Bloch vectors are drawn in each Bloch sphere, and they represent K₁ and K₂ described in (equation 7). The Bloch vectors to be displayed may be put together when the Bloch vectors are not changed by the one-qubit operation.

“The diagram representing the quantum entanglement” denotes one point in the cube or one point in the tetrahedron representing the quantum entanglement generation part A. The combination of two Bloch spheres and one point in the cube is not unique, and therefore, a plurality of combinations can be generally displayed. The user can select an optional combination and draw the property of the combination.

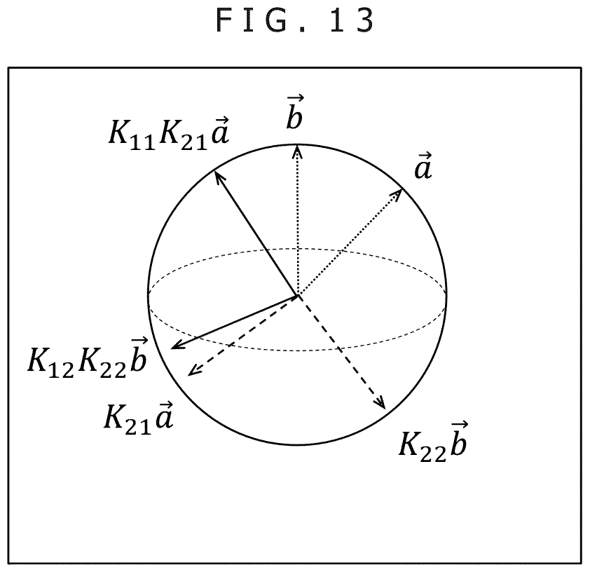

FIG. 13 illustrates another example of display. The Bloch vectors may be displayed together in one Bloch sphere. In this display method, six Bloch vectors of vec{a}, K₂₁vec{a}, K₁₁K₂₁vec{a}, vec{b}, K₂₂vec{b}, and K₁₂K₂₂vec{b} are displayed in one Bloch sphere. FIG. 13 illustrates an example of displaying the six Bloch vectors together in one Bloch sphere.

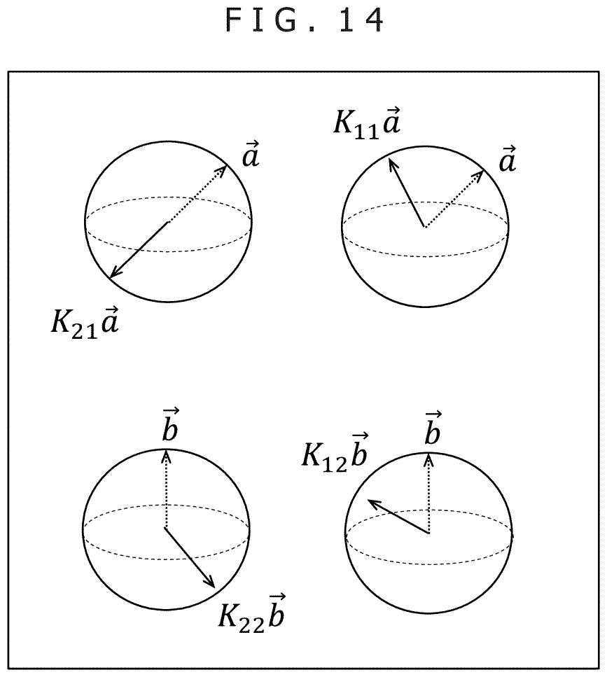

FIG. 14 illustrates another example of display. In addition, four Bloch spheres can be used to represent (K₁₁, K₁₂, K₂₁, K₂₂). Two Bloch vectors are drawn in each Bloch sphere. In the Bloch spheres, vec{a} and K₂₁vec{a}, vec{a} and K₁₁vec{a}, vec{b} and K₂₂vec{b}, and vec{b} and K₁₂vec{b} are displayed, respectively. FIG. 14 illustrates an example of using the four Bloch spheres to display the Bloch vectors.

The quantum entanglement generation structure of the two-qubit operation can be uniquely represented by one point in the tetrahedron 1200 illustrated in FIG. 12. Therefore, displaying the degree of the quantum entanglement generation of the two-qubit operation on the tetrahedron enables the level of the quantum entanglement provided by the target operation to be visualized. In the present embodiment, a strength of quantum entanglement ep(U) is introduced as an index, and the relationship with the coordinates in the tetrahedron will be described.

The strength of quantum entanglement ep(U) of the 4×4 special unitary matrix U representing the two-qubit operation is defined as in the following (equation 8) by using (c₁, c₂, c₃) defined by (equation 7).

$$\begin{matrix}[ Expression 8 ] & \\ ep ( U ) = \frac{2}{9} ( 1 - {cos}^{2} {c}_{1} {cos}^{2} {c}_{2} {cos}^{2} {c}_{3} - {sin}^{2} {c}_{1} {sin}^{2} {c}_{2} {sin}^{2} {c}_{3} ) & ( equation 8 )\end{matrix}$$

The range of ep(U) is equal to or greater than 0 and equal to or smaller than 2/9. The point satisfying ep(U)= 2/9 corresponds to the operation that provides the maximal strength of quantum entanglement.

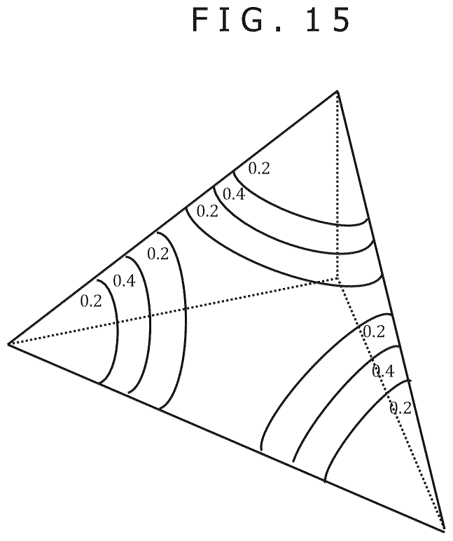

FIG. 15 illustrates the relationship between each point in the tetrahedron and the strength of quantum entanglement. Solid lines are used to illustrate contours in which the ratio of the strength of quantum entanglement to the maximal strength of quantum entanglement is 0.2 or 0.4. The contours indicate the strength distribution of the quantum entanglement. The user can freely select the values of the contours to be displayed. In the present embodiment, a method of obtaining (K₁, K₂, A) and (c₁, c₂, c₃) from the special unitary matrix U will be described.

First, U_{B}=Q⁺UQ is calculated. Here, Q denotes a matrix defined by (Expression 9), and Q⁺ denotes a complex conjugate matrix of Q.

$$\begin{matrix}[ Expression 9 ] & \\ Q = \frac{1}{\sqrt{2}} ( \begin{matrix}1 & 0 & 0 & i \\ 0 & i & 1 & 0 \\ 0 & i & - 1 & 0 \\ 1 & 0 & 0 & - i\end{matrix} ) & ( equation 9 )\end{matrix}$$

Next, m=U_{B}^{T}U_{B} is diagonalized. The matrix m can be diagonalized by using an SO(4) matrix O₂, and the matrix m can be written as m=O₂^{T}F₂ O₂. Here, F₂ is a diagonal matrix.

Next, U_{B}, F₂, and O₂ described above are used to obtain K₁, K₂, and A. K₂ is obtained by K₂=QO₂Q⁺, A is obtained by A=QFQ⁺ using a diagonal matrix F satisfying FF=F₂, and K₁ is obtained by K₁=QO₁Q⁺ using a matrix O₁=U_{B}O₂^{T}F⁻¹ defined by using an inverse matrix F⁻¹ of F.

Lastly, a procedure of obtaining (c₁, c₂, c₃) from the matrix A will be illustrated. First, (g₁, g₂, g₃) defined by (equation 10) are calculated.

$$\begin{matrix}[ Expression 10 ] & \\ {g}_{1} = Re [ \frac{{( Tr [ m ] )}^{2}}{16 det U} ] & ( equation 10 )\end{matrix}$$

$${g}_{2} = Im [ \frac{{( Tr [ m ] )}^{2}}{16 det U} ]$$

$${g}_{3} = \frac{{( Tr [ m ] )}^{2} - Tr [ {m}^{2} ]}{4 det U}$$

It is known that the relationship between (g₁, g₂, g₃) and (c₁, c₂, c₃) is the relationship as in (equation 11), and therefore, the equations of (equation 11) are solved to obtain (c₁, c₂, c₃).

$$\begin{matrix}[ Expression 11 ] & \\ {g}_{1} = {cos}^{2} {c}_{1} {cos}^{2} {c}_{2} {cos}^{2} {c}_{3} - {sin}^{2} {c}_{1} {sin}^{2} {c}_{2} {sin}^{2} {c}_{3} & ( equation 11 )\end{matrix}$$

$${g}_{2} = \frac{1}{4} sin 2 {c}_{1} sin 2 {c}_{2} sin 2 {c}_{3}$$

$${g}_{3} = 4 {cos}^{2} {c}_{1} {cos}^{2} {c}_{2} {cos}^{2} {c}_{3} - 4 {sin}^{2} {c}_{1} {sin}^{2} {c}_{2} {sin}^{2} {c}_{3} - cos 2 {c}_{1} cos 2 {c}_{2} cos 2 {c}_{3}$$

There are generally a plurality of solutions, and (c₁, c₂, c₃) satisfying the formula of A described in (equation 7) are selected from among the solutions.

Next, the local equivalent operation (S808) of moving the coordinates (c₁, c₂, c₃) representing the quantum entanglement generation operation A into the tetrahedron described in FIG. 12 will be escribed. The local equivalent operation denotes redefinition of (K₁, K₂).

FIG. 16 illustrates a flow of the local equivalent operation. First, whether all of (c₁, c₂, c₃) are equal to or greater than 0 and smaller than π is checked (S1601), and a local equivalent operation 1 (S1602) described below is executed if there is a component not equal to or greater than 0 and smaller than π.

Next, whether c₁>=c₂>=c₃ is satisfied is checked (S1603), and a local equivalent operation 2 (S1604) described below is executed if the condition is not satisfied.

Next, whether c₁+c₂<=π is satisfied is checked (S1605), and a local equivalent operation 3 (S1606) described below is executed if the condition is not satisfied.

Lastly, the values of c₁ and c₃ are checked (S1607), and a local equivalent operation 4 (S1608) described below is executed if c₃=0 and c₁>π/2.

The coordinates (c₁, c₂, c₃) obtained through the local equivalent operations are one point in the tetrahedron (S1609). The coordinates obtained in the tetrahedron as a result of redefining (K₁, K₂) through the local equivalent operations are equivalent to the original coordinates in a sense that the quantum entanglement is illustrated. The coordinates are displayed in the tetrahedron, and the relationship with the strength of quantum entanglement is more clearly displayed.

Through the method, the Bloch vectors and the tetrahedron coordinates can be used to represent the results of the local equivalent operations. The user can select a favorable stage of the calculation from the input apparatus 6 and draw the Bloch vectors and the tetrahedron coordinates of the operation results at that time. Next, the local equivalent operation 1 will be described.

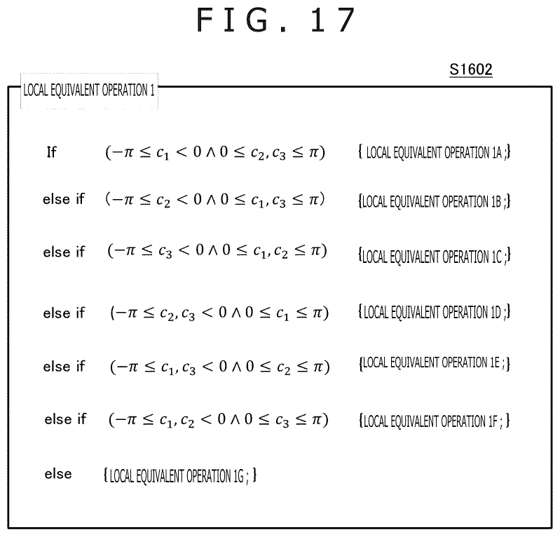

FIG. 17 illustrates details of the local equivalent operation 1 (S1602).

If c₁ is equal to or greater than −π and smaller than 0, and c₂ and c₃ are both equal to or greater than 0 and equal to or smaller than π, a local equivalent operation 1A described below is executed.

If c₂ is equal to or greater than −π and smaller than 0, and c₃ and c₁ are both equal to or greater than 0 and equal to or smaller than π, a local equivalent operation 1B described below is executed.

If c₃ is equal to or greater than −π and smaller than 0, and c₁ and c₂ are both equal to or greater than 0 and equal to or smaller than π, a local equivalent operation 1C described below is executed.

If c₁ is equal to or greater than 0 and equal to or smaller than π, and c₂ and c₃ are both equal to or greater than −π and smaller than 0, a local equivalent operation 1D described below is executed.

If c₂ is equal to or greater than 0 and equal to or smaller than π, and c₃ and c₁ are both equal to or greater than −π and smaller than 0, a local equivalent operation 1E described below is executed.

If c₃ is equal to or greater than 0 and equal to or smaller than π, and c₁ and c₂ are both equal to or greater than −π and smaller than 0, a local equivalent operation 1F described below is executed.

If c₁, c₂, and c₃ are all equal to or greater than −π and smaller than 0, a local equivalent operation 1G described below is executed.

Next, the local equivalent operation 2 will be described.

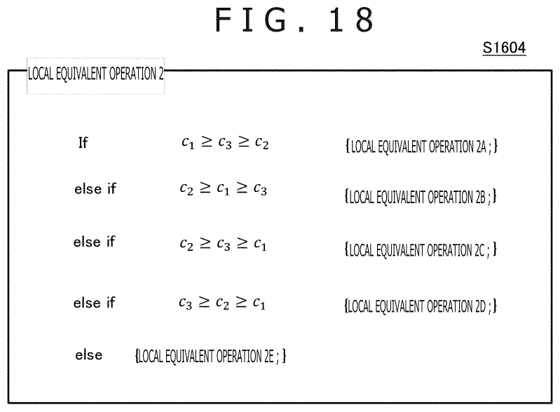

FIG. 18 illustrates details of the local equivalent operation 2 (S1604).

If c₁>=c₃>=c₂, a local equivalent operation 2A described below is executed.

If c₂>=c₁>=c₃, a local equivalent operation 2B described below is executed.

If c₂>=c₃>=c₁, a local equivalent operation 2C described below is executed.

If c₃>=c₂>=c₁, a local equivalent operation 2D described below is executed.

If c₃>=c₁>=c₂, a local equivalent operation 2E described below is executed.

Hereinafter, the local equivalent operations 1A to 1G, 2A to 2E, 3, and 4 will be described. All of the local equivalent operations represent replacement of (K₁, K₂, c₁, c₂, c₃).

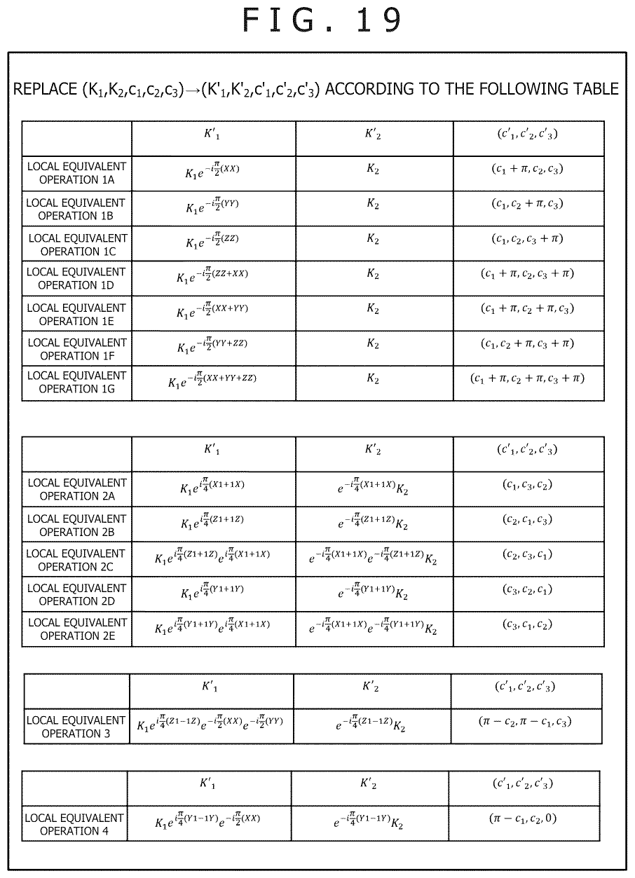

FIG. 19 illustrates definition of each operation of the local equivalent operations. As described below, (K₁, K₂, c₁, c₂, c₃) are replaced with (K′1, K′2, C′1, C′2, C′ 3).

The local equivalent operation 1A represents an operation of replacing K₁ with K₁ exp(−i(π/2)XX) and replacing (c₁, c₂, c₃) with (c₁+π, c₂, c₃).

The local equivalent operation 1B represents an operation of replacing K₁ with K₁ exp(−i(π/2)YY) and replacing (c₁, c₂, c₃) with (c₁, c₂+π, c₃).

The local equivalent operation 1C represents an operation of replacing K₁ with K₁ exp(−i(π/2)ZZ) and replacing (c₁, c₂, c₃) with (c₁, c₂, c₃+π).

The local equivalent operation 1D represents an operation of replacing K₁ with K₁ exp(−i(π/2)(ZZ+XX)) and replacing (c₁, c₂, c₃) with (c₁+π, c₂, c₃+π).

The local equivalent operation 1E represents an operation of replacing K₁ with K₁ exp(−i(π/2)(XX+YY)) and replacing (c₁, c₂, c₃) with (c₁, c₂+π, c₃+π).

The local equivalent operation 1F represents an operation of replacing K₁ with K₁ exp(−i(π/2)(YY+ZZ)) and replacing (c₁, c₂, c₃) with (c₁+π, c₂+π, c₃).

The local equivalent operation 1G represents an operation of replacing K₁ with K₁ exp(−i(π/2)(XX+YY+ZZ)) and replacing (c₁, c₂, c₃) with (c₁+π, c₂+π, c₃+π).

The local equivalent operation 2A represents an operation of replacing K₁ with K₁ exp(i(π/4)(XI+IX)), replacing K₂ with exp(−i(π/4)(XI+IX)) K₂, and replacing (c₁, c₂, c₃) with (c₁, c₃, c₂).

The local equivalent operation 2B represents an operation of replacing K₁ with K₁ exp(i(π/4)(ZI+IZ)), replacing K₂ with exp(−i(π/4)(ZI+IZ)) K₂, and replacing (c₁, c₂, c₃) with (c₂, c₁, c₃).

The local equivalent operation 2C represents an operation of replacing K₁ with K₁ exp(i(π/4)(ZI+IZ)) exp(i(π/4)(XI+IX)), replacing K₂ with exp(−i(π/4)(XI+IX)) exp(−i(π/4)(ZI+IZ)) K₂, and replacing (c₁, c₂, c₃) with (c₂, c₃, c₁).

The local equivalent operation 2D represents an operation of replacing K₁ with K₁ exp(i(π/4)(YI+IY)), replacing K₂ with exp(−i(π/4)(YI+IY)) K₂, and replacing (c₁, c₂, c₃) with (c₃, c₂, c₁).

The local equivalent operation 2E represents an operation of replacing K₁ with K₁ exp(i(π/4)(YI+IY)) exp(i(π/4)(XI+IX)), replacing K₂ with ₂exp(−i(π/4)(XI+IX)) exp(−i(π/4)(YI+IY)) K₂, and replacing (c₁, c₂, c₃) with (c₃, c₁, c₂).

The local equivalent operation 3 represents an operation of replacing K₁ with K₁ exp(i(π/4)(ZI−IZ)) exp(−i(π/2)XX) exp(−i(π/2)YY), replacing K₂ with exp(−i(π/4)(ZI−IZ)) K₂, and replacing (c₁, c₂, c₃) with (π−c₂, π−c₁, c₃).

The local equivalent operation 4 represents an operation of replacing K₁ with K₁exp(i(π/4)(YI−IY))exp(−i(π/2)XX), replacing K₂ with exp(−i(π/4)(YI−IY)) K₂, and replacing (c₁, c₂, c₃) with (π−c₁, π−c₂, 0).

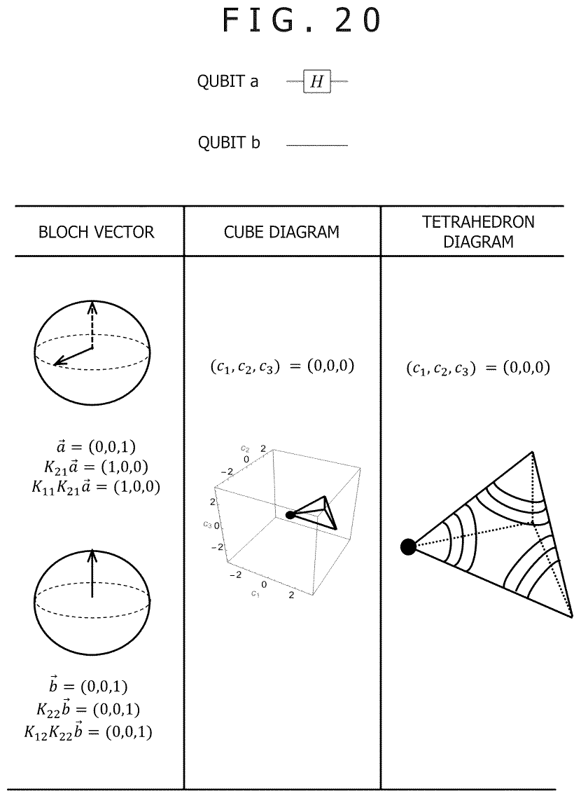

The display method for the two-qubit operation has been described so far. Hereinafter, specific examples of the display of the two-qubit operation will be illustrated. Here, Uₐ=H1, U_{b}=(root SWAP) (HI), and U_{c}=(CNOT) (HI) will be considered as examples of an operation without quantum entanglement Uₐ, a moderate quantum entanglement generation operation U_{b}, and a maximal entanglement generation operation U_{c}, and examples of display of the respective two-qubit operation will be illustrated in FIGS. 20 to 22.

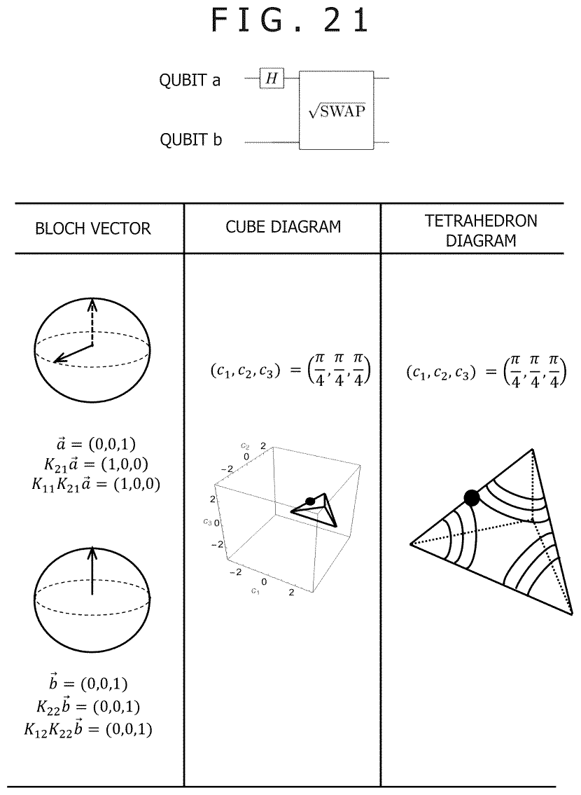

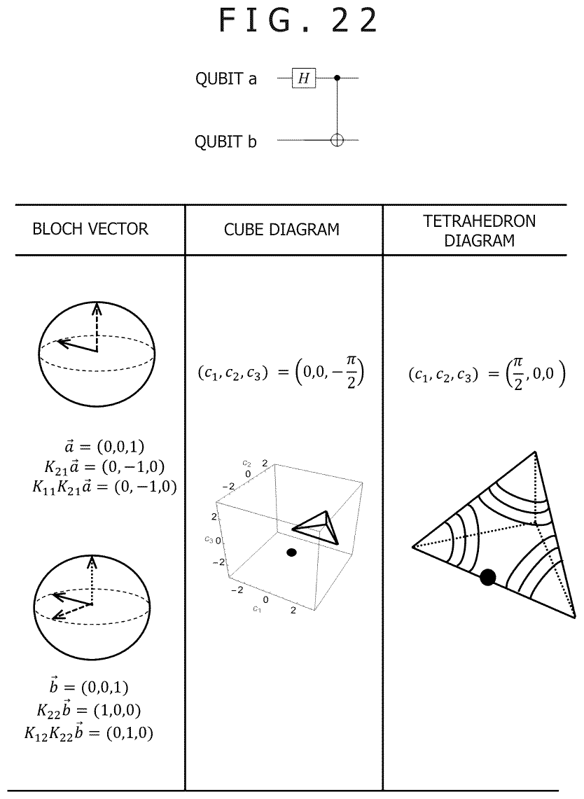

FIG. 20 illustrates an example of display of the operation without quantum entanglement Uₐ. In the table of FIG. 20, the left column illustrates the Bloch vectors, the center column illustrates a cube diagram of the quantum entanglement, and the right column illustrates a tetrahedron diagram representing the quantum entanglement generation structure. One side of the cube is π, and the center of gravity is at the origin. A tetrahedron is illustrated by plotting areas satisfying −π≤c₁≤π, −π≤c₂≤π, −π≤c₁≤π, 0≤c₃<c₂<c₁<π, and c₁+c₂≤π (similar in FIGS. 21 and 22).

The operation without quantum entanglement Uₐ does not include the operation of generating the quantum entanglement, and A=II(4×4 unit matrix) holds in the decomposition of (equation 7). Therefore, c₁=c₂=c₃=0 holds, and A corresponds to the origin in the cube and the tetrahedron. K₁ and K₂ are K₁=II and K₂=HI, respectively. Therefore, the Bloch vector of the qubit a changes according to the H operation, and the Bloch vector of the vector b does not change. Assuming that the Bloch vectors before the operation are vec{a}=vec{b}=(0, 0, 1) as a standard, K₂₁vec{a}=(1, 0, 0), K₁₁K₂₁vec{a}=(1, 0, 0), K₂₂vec{b}=(0, 0, 1), and K₁₂K₂₂vec{b}=(0, 0, 1) are obtained.

FIG. 21 illustrates an example of display of the moderate quantum entanglement generation operation U_{b}. The moderate entanglement generation operation U_{b} can be decomposed into K₁=II, K₂=HI, A=exp(−iπ/8(XX+YY+ZZ)). The quantum entanglement generation operation is non-trivial, and c₁=c₂=c₃=π/4 holds. The coordinates are in the tetrahedron. K₁ and K₂ are equal to those of the operation without quantum entanglement Uₐ, and the representation of the Bloch vectors is also the same.

FIG. 22 illustrates an example of display of the maximal quantum entanglement generation operation U_{c}. The maximal entanglement generation operation U_{c} can be decomposed into K₁=IH, K₂=(RzRz)*HH, A=exp(−iπ/4(ZZ)). Here, Rz is defined as Rz=exp(iπ/4(Z)). The quantum entanglement generation operation is A=exp(−iπ/4(ZZ)), and the corresponding coordinates are c₁=c₂₌₀ and c₃=−π/2. Therefore, the point is outside the tetrahedron. The coordinates in the tetrahedron can be acquired by the local equivalent operation, and the results are c₁=π/2 and c₂=c₃=0. Next, the changes in the Bloch vectors of the qubits a and b will be considered based on K₁ and K₂. The Rz operation acts on the qubit a first, and then H acts on the qubit a. On the other hand, H acts on the qubit b first, and then the Rz operation and the H operation sequentially act on the qubit b. Assuming that the Bloch vectors before the operation are vec{a}=vec{b}=(0, 0, 1) as a standard, K₂₁vec{a}=(0, −1, 0), K₁₁K₂₁vec{a}=(0, −1, 0), K₂₂vec{b}=(1, 0, 0), and K₁₂K₂₂vec{b}=(0, 1, 0) are obtained.

As illustrated in FIGS. 20 to 22, the generation state of the quantum entanglement in the operation can be represented by the position of the point with respect to the cube or the tetrahedron in the present embodiment.

As described above, the solution (K₁, K₂, A) to the Cartan decomposition illustrated in (equation 7) or FIG. 10 is generally not uniquely determined. Therefore, there are generally a plurality of Bloch vectors and coordinates in cube representing the same operation U. The decompositions are related to each other by the local equivalent operation. The user can output arbitrary Bloch vectors and cube coordinates related by the local equivalent operation.

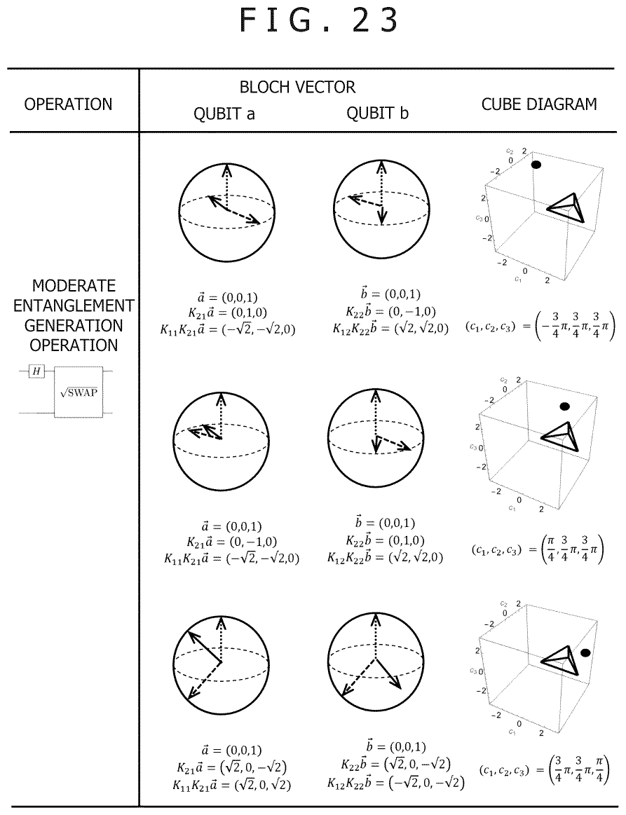

FIG. 23 illustrates various examples of display of the moderate entanglement generation operation U_{b}=(rootSWAP) (HI). Here, three types of (K₁, K₂, A) as well as Bloch spheres and cubes representing them are drawn.

The upper row of FIG. 23 indicates vec{a}=vec{b}=(0, 0, 1), K₂₁vec{a}=(0, 1, 0), K₁₁K₂₁vec{a}=(−2^{1/2}, −2^{1/2}, 0), K₂₂vec{b}=(0, −1, 0), K₁₂K₂₂vec{b}=(2^{1/2}, 2^{1/2}, 0), and (c₁, c₂, c₃)=(−3π/4, 3π/4, 3π/4,), the middle row of FIG. 23 indicates vec{a}=vec{b}=(0, 0, 1), K₂₁vec{a}=(0, −1, 0), K₁₁K₂₁vec{a}=(−2^{1/2}, −2^{1/2}, 0), K₂₂vec{b}=(0, 1, 0), K₁₂K₂₂vec{b}=(2^{1/2}, 2^{1/2}, 0), and (c₁, c₂, c₃)=(π/4, 3π/4, 3π/4,), and the lower row of FIG. 23 indicates vec{a}=vec{b}=(0, 0, 1), K₂₁vec{a}=(2^{1/2}, 0, −2^{1/2}), K₁₁K₂₁vec{a}=(2^{1/2}, 0, 2^{1/2}), K₂₂vec{b}=(2^{1/2}, 0, −2^{1/2}), K₁₂K₂₂vec{b}=(−2^{1/2}, 0, −2^{1/2}), and (c₁, c₂, c₃)=(3π/4, 3π/4, π/4,). In any case, when U is calculated from (Expression 7), U coincides with U_{b}=(rootSWAP) (HI). In any decomposition, c₁=c₂=c₃=π/4 holds when the local equivalent operation is performed to obtain the coordinates in the tetrahedron.

The operation to be implemented in the quantum calculator can also be specifically designated as a quantum operation to be input. A Hamiltonian operator H representing the physics of the quantum calculator is used to define the quantum operation U in that case as in (equation 12).

$$\begin{matrix}[ Expression 12 ] & \\ U ( t ) = T exp ( - \frac{i}{ℏ} {\int }_{0}^{t} H ( {t}^{′} ) {dt}^{′} ) & ( equation 12 )\end{matrix}$$

Here, t represents time, and hbar represents a reduced Planck constant. T on the right side denotes a time-ordered product. U=exp(−iHt/hbar) holds when the Hamiltonian does not depend on time. In this case, the Bloch vectors and the coordinates in the cube or the tetrahedron described in embodiment 2 are functions of parameters of the Hamiltonian. By checking how much the tetrahedron can be occupied when the parameters of the Hamiltonian are changed, the breadth of classes of the quantum entanglement generation operation that can be implemented on the quantum calculator can be analyzed. In addition, by comparing the Bloch vectors and the cube coordinates of the operation including the Hamiltonian with those of the desirable operation and observing the difference, how much the parameters of the quantum calculator (Hamiltonian) need to be adjusted to realize the desirable operation can be recognized. In this way, the visualization technique of the present embodiment is also useful for designing the quantum calculator.

### Embodiment 3

In the present embodiment, the two-qubit state or the two-qubit operation is input, and the property of the designated two-qubit state and operation is output in a manner that the quantum entanglement becomes apparent. In the present embodiment, the example of the input in embodiment 1 will be specifically illustrated to illustrate a use case of the present embodiment. The quantum circuit diagram is the input information in visualizing the two-qubit operation, and the operation result is the input information in visualizing the two-qubit state.

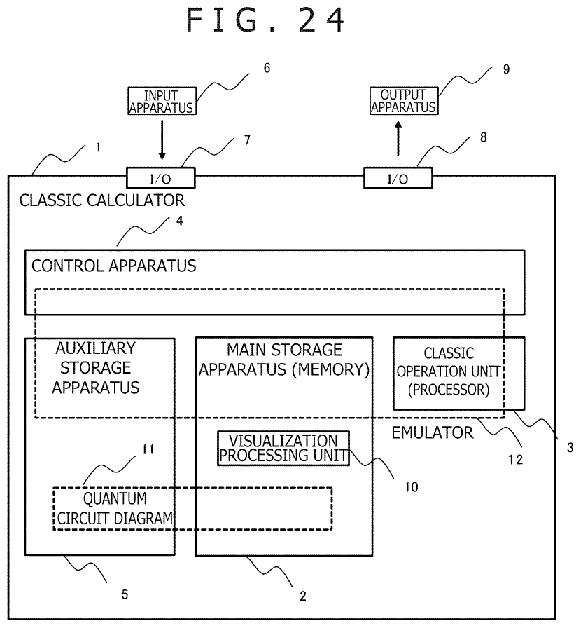

FIG. 24 illustrates an example of the use case. An emulator 12 in the classic calculator 1 executes the operation in the case described here. The emulator denotes an apparatus that uses the main storage apparatus 2, the classic operation unit 3, the control apparatus 4, and the auxiliary storage apparatus 5 in the classic calculator to simulate the quantum calculator. The emulator 12 has a function of performing the matrix operation corresponding to the quantum circuit diagram on the classic calculator to simulate the quantum calculation.

The visualization processing unit 10 receives, as input information, the result of the operation executed by the emulator 12 based on the quantum circuit diagram 11 and executes the process described in embodiment 1. The output result (diagram representing the Bloch sphere and the quantum entanglement) is displayed on the output apparatus 9 such as a display, through the output interface 8 (in the case of the state display). In the case of displaying the operation, the quantum circuit diagram 11 is the input information, and the output result is displayed on the output apparatus 9 through the process described in embodiment 2.

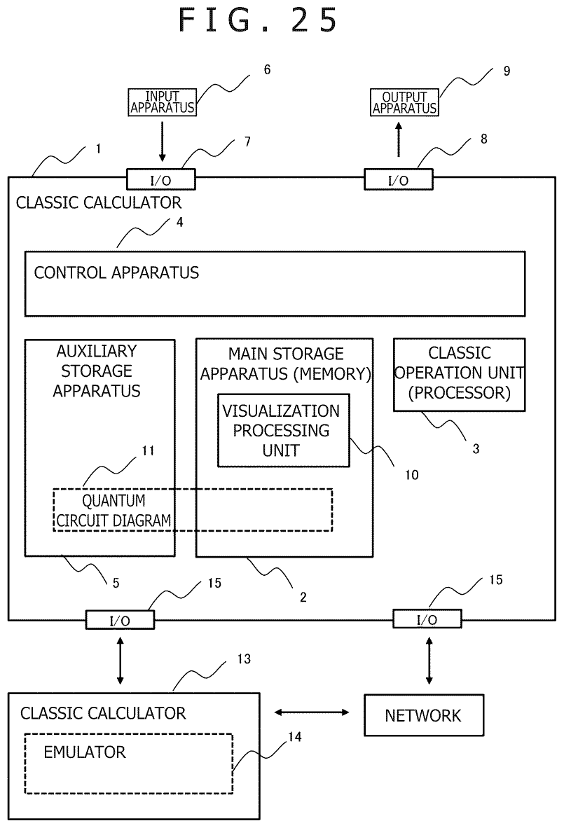

FIG. 25 illustrates another example of the use case. In the case described here, an emulator 14 in a classic calculator 13 outside of the classic calculator 1 performs the quantum operation that is the input information. The classic calculator 13 has properties similar to those of the classic calculator 1 except for the visualization processing unit. The result of the operation executed by the emulator 14 in the classic calculator 13 is transmitted to the classic calculator 1 through an input-output interface 15, and the operation result is saved in the main storage apparatus 2 or the auxiliary storage apparatus 5 of the classic calculator 1. The classic calculator 1 and the classic calculator 13 may be physically connected or may be connected through a network. The visualization processing unit 10 in the classic calculator 1 receives the operation results as input information and executes the process of embodiment 1. The output result (diagram representing the Bloch sphere and the quantum entanglement) is displayed on the output apparatus 9 such as a display, through the output interface 8. In the case of displaying the operation, the process described in embodiment 2 is similarly carried out based on the information on the quantum circuit diagram 11 saved in the classic calculator 1.

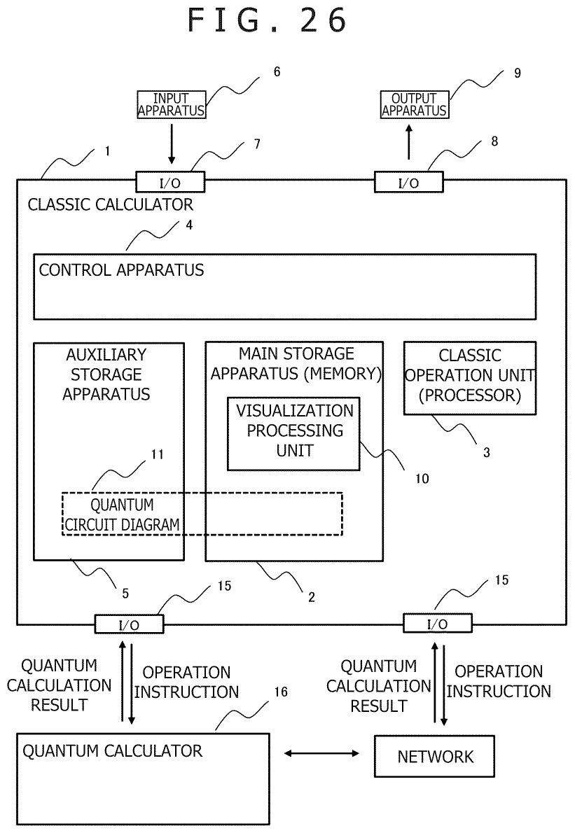

FIG. 26 illustrates another example of the use case. In the case described here, the operation result is received from a quantum calculator 16 outside of the classic calculator 1. The quantum calculator 16 includes a plurality of qubits, and the operation on the qubits is executed according to an operation instruction from the classic calculator 1. The operation instruction is transmitted through the input-output interface 15. The information on the qubits and the operation in the quantum calculator 16 is transmitted to the classic calculator through the input-output interface 15, and the information is saved as the quantum circuit diagram 11 in the main storage apparatus 2 or the auxiliary storage apparatus 5 in the classic calculator 1. The classic calculator 1 and the quantum calculator 16 may be physically connected or may be connected through a network. The visualization processing unit 10 in the classic calculator 1 receives the quantum circuit diagram 11 as input information and executes the process described in embodiment 1. The output result (diagram representing the Bloch sphere and the quantum entanglement) is displayed on the output apparatus 9 such as a display, through the output interface 8. In the case of displaying the operation, the process described in embodiment 2 is carried out based on the information on the quantum circuit diagram 11 saved in the classic calculator 1 as is the case of embodiment 18.

In embodiment 3, not only the state, but also the operation is visualized. In either case, the input information is obtained from the result of the operation executed by the emulator or the quantum calculator. The operation in the quantum calculator can be defined by the operation instruction transmitted from the classic calculator of FIG. 26. In addition, the operation in the quantum calculator can also be defined by the change in the quantum state in the quantum calculator.

In this way, the information for the visualization can be obtained from the quantum circuit diagram, the emulator in the information processing apparatus including the visualization processing unit, the emulator in the calculator outside of the information processing apparatus, and the quantum calculator inside or outside of the information processing apparatus.

According to the embodiments described above in detail, the two-qubit state is displayed by, for example, the diagram illustrating the Bloch sphere and the quantum entanglement. For example, a 3×3 bar graph or an ellipse is used for the diagram illustrating the quantum entanglement. In addition, not only the two-qubit state, but also the two-qubit operation can be displayed in the embodiments. In that case, the quantum entanglement is displayed by one point in the cube or one point in the tetrahedron. As a result, the quantum entanglement and the quantum entanglement generation structure can be intuitively understood, and the quantum calculator and the quantum algorithm can be efficiently developed.

According to the embodiments, the quantum computer can be efficiently operated. Therefore, the quantum computer consumes less energy, and the carbon emission can be reduced. This can prevent global warming and contribute to sustainable society.

### REFERENCE SIGNS LIST

1: classic calculator including visualization processing unit
2: main storage apparatus
3: classic operation unit
4: control apparatus
5: auxiliary storage apparatus
6: input apparatus
7: input interface
8: output interface
9: output apparatus
10: visualization processing unit
11: quantum circuit diagram as input
12: emulator inside of classic calculator 1
13: classic calculator outside of classic calculator 1
14: emulator inside of classic calculator 13
15: input-output interface connected to external calculator
16: quantum calculator

1. An information processing apparatus comprising:
an input interface that receives at least one of information on a state of a plurality of qubits and information on an operation related to a plurality of qubits;
a visualization processing unit that generates a parameter for visualizing at least one of a state of two arbitrary qubits of the plurality of qubits and an operation related to two arbitrary qubits in the operation related to the plurality of qubits; and
an output interface that outputs output information based on the parameter, wherein
the information processing apparatus displays, on an output apparatus, a diagram representing a Bloch sphere and quantum entanglement based on the output information.

2. The information processing apparatus according to claim 1, wherein
the visualization processing unit calculates the parameter based on a density matrix of the state of the two qubits.

3. The information processing apparatus according to claim 2, wherein
the diagram representing the quantum entanglement is a diagram in which at least either values or a graph is displayed to represent a qubit correlation matrix obtained based on the density matrix.

4. The information processing apparatus according to claim 2, wherein
the diagram representing the quantum entanglement is a diagram illustrating a space in which an ellipse inside of a 3-sphere with radius of 1 is a boundary, the space being based on non-negative singular values of a qubit correlation matrix obtained based on the density matrix.

5. The information processing apparatus according to claim 2, wherein
Bloch vectors illustrated in the Bloch sphere are generated based on elements obtained by decomposing the density matrix, and a length of the Bloch vectors represents a level of the quantum entanglement.

6. The information processing apparatus according to claim 5, wherein
the number of Bloch spheres is two, and the Bloch vectors are displayed in the respective Bloch spheres, or the number of Bloch spheres is one, and two Bloch vectors are displayed according to the state of the two qubits.

7. The information processing apparatus according to claim 1, wherein
the visualization processing unit calculates the parameter based on a unitary matrix representing the operation related to the two qubits.

8. The information processing apparatus according to claim 7, wherein
Bloch vectors illustrated in the Bloch sphere are generated based on an operation acting on only one qubit obtained by decomposing the unitary matrix.

9. The information processing apparatus according to claim 8, wherein
the Bloch vectors illustrated in the Bloch sphere are six vectors including vectors generated based on four operations acting on only one qubit obtained by applying Cartan decomposition to the unitary matrix, and the six vectors are displayed together or dispersed and displayed in one or a plurality of Bloch spheres.

10. The information processing apparatus according to claim 7, wherein
the diagram representing the quantum entanglement is a diagram displaying a point indicated by a set of three real numbers generated based on a two-qubit operation and obtained by applying Cartan decomposition to the unitary matrix, the point being superimposed on a cube having one side of length π and a center of gravity at an origin and superimposed on a tetrahedron including a set of (c₁, c₂, c₃) satisfying c₁<=π/2 when 0<=c₃<=c₂<=c₁<T, c₁+c₂<=T, and c₃=0.

11. The information processing apparatus according to claim 10, wherein
when the point indicated by the set of three real numbers is positioned outside of the tetrahedron, the information processing apparatus performs a local equivalent operation to change the position of the point indicated by the set of three real numbers to a position in the tetrahedron and displays a degree of the quantum entanglement as a strength distribution on the tetrahedron.

12. The information processing apparatus according to claim 1, wherein
the information processing apparatus obtains at least one of the information on the state of the plurality of qubits and the information on the operation related to the plurality of qubits from a quantum circuit diagram, an emulator in the information processing apparatus that is a classic calculator including the visualization processing unit, an emulator in another classic calculator outside of the information processing apparatus, and a quantum calculator inside or outside of the information processing apparatus.

13. An information processing method executed by an information processing apparatus including an input interface, an output interface, a storage apparatus, an operation unit, and a visualization processing unit,
the visualization processing unit executing:
an input step of receiving at least one of information on a state of a plurality of qubits and information on an operation related to a plurality of qubits;
a visualization step of generating a parameter group for visualizing at least one of a state of two arbitrary qubits in the plurality of qubits and an operation related to two arbitrary qubits in the operation related to the plurality of qubits; and
an output step of outputting output information based on the parameter group to display a diagram representing a Bloch sphere and quantum entanglement on an output apparatus based on the parameter group.

14. The information processing method according to claim 13, wherein,
in the input step, the information on the state of the plurality of qubits is received,
in the visualization step, a first step of acquiring a density matrix of a two-qubit state from the information on the state of the plurality of qubits and a second step of calculating a qubit correlation matrix and a density matrix of single qubits from the density matrix are executed, and
in the output step, a first parameter for displaying a 3×3 matrix representing quantum entanglement based on the density matrix of the two-qubit state and a second parameter for displaying Bloch vectors to be displayed on the Bloch sphere based on the density matrix of the single qubits are output.

15. The information processing method according to claim 13, wherein,
in the input step, the information on the operation related to the plurality of qubits is received,
in the visualization step, a third step of acquiring a unitary matrix representing a two-qubit operation from the information on the operation related to the plurality of qubits and a fourth step of obtaining a first operation decomposing the unitary matrix and acting on single qubits alone and a second operation acting on two qubits are executed, and
in the output step, a third parameter for displaying Bloch vectors to be displayed in the Bloch sphere based on the first operation is output, and a fourth parameter for displaying a point inside or outside of a tetrahedron in a cube having one side of π based on the second operation, the point being displayed on top of the cube and the tetrahedron, is output.
